(19) United States
(12) Patent Application Publication
(10) Pub. No.: US 2008/0177999 A1
(43) Pub. Date: Jul. 24, 2008

(54) CONTENT PROVIDING APPARATUS AND METHOD, CONTENT USING APPARATUS AND METHOD, AND CONTENT PROVIDING APPARATUS AND METHOD FOR REVOKING CONTENT USING APPARATUS

(75) Inventors: Mi-hwa PARK, Anyang-si (KR); Myung-sun KIM, Uiwang-si (KR); Hak-soo JU, Suwon-si (KR); Ji-young MOON, Suwon-si (KR); Ju-hee SEO, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/017,678

(22) Filed: Jan. 22, 2008

(30) Foreign Application Priority Data
Jan. 19, 2007 (KR) 10-2007-0006294

(51) Int. Cl. H04L 9/00

(52) U.S. Cl. 713/161

(57) ABSTRACT

Provided are an apparatus and method for determining the integrity of content in at least one packet of a plurality of packets. A content using apparatus includes a receiver which receives a transport packet including content in at least one packet and a secret set, which includes an integrity check key generated for determining the integrity of the content, and extracts the secret set by processing the transport packet, a storage unit which stores the secret set, a controller which uses the secret set to determine whether each packet having the content maintains integrity, and a data processing unit which processes the at least one packet if the at least one packet is determined to be maintaining integrity. Accordingly, when content is transmitted, the integrity of the content can be checked using only a small amount of transmission data and a small amount of computation.

### CROSS-REFERENCE TO RELATED PATENT APPLICATION

This application claims priority from Korean Patent Application No. 10-2007-0006294, filed on Jan. 19, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to a providing and determining the integrity of content.

Apparatuses and methods consistent with the present invention also relate to determining whether a content using apparatus receiving and using content from the content providing apparatus is an authorized apparatus, if it is determined that the content using apparatus is an unauthorized apparatus, the content using apparatus is revoked.

2. Description of the Related Art

Unlike analog data, digital content has a lossless copy characteristic and easy copy and distribution characteristics due to easy reuse, processing, and distribution. Since much money and time are necessary to produce digital content, illegal copying and distribution of the digital content becomes a problem. In order to protect content and content producers from illegal copying, Digital Rights Management (DRM) has been intensely studied, and many services using DRM have been introduced.

DRM is the technology of safely protecting rights and benefits of content providers, preventing illegal copying, and supporting, from the creation to distribution, management of content, such as pay-for-use billing and settlement agencies. One technology for determining the integrity of DRM content, i.e., determining whether the DRM content has been modified by an unauthorized person, is a method of using Message Authentication Code (MAC).

FIG. 1 is a diagram for describing a method of determining the integrity of DRM content using MAC. As illustrated in FIG. 1, if MAC data is attached to each packet constituting content, the total amount of data increases by the amount of MAC data. That is, if the number of packets is n, data overhead due to the MAC data is large. In addition, although a method of using a digital signature is another method for determining the integrity of content, the amount of computation increases when the method of using a digital signature is employed.

A DRM content providing apparatus determines whether an apparatus receiving and using DRM content is an authorized apparatus. The apparatus using DRM content can determine whether a device communicating with the apparatus is an authorized device, by receiving a certificate from a certification laboratory issuing the certificate. The certificate contains information indicating an expiration date of the certificate, and the certificate may be revoked even prior to the expiration date. For example, if a secret key of a specific device is damaged or open to the outside, a certificate of the specific device may be revoked so that other devices can see that the certificate has been revoked.

One of methods of determining whether a non-expired certificate is revoked is a Certificate Revocation List (CRL) method, i.e., a method of issuing a revoked certificate list in a certification laboratory. However, in order to use the CRL method, devices must maintain an online state, and management of the CRL is complex. Another method of determining whether a non-expired certificate is revoked is a method of determining an authorized device using a Media Key Block (MKB) in a storage medium, but this has problems in that at least 18 months are taken to detect devices to be revoked and reflect the devices on the MKB and the amount of data of device keys required to generate the MKB is too large. In addition, if all the devices of the same model are considered as a single device, then all the devices of the same model, one of which is a device determined as a revoked device by a content provider, cannot be used, and thus, users authorized to use the content may suffer.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a content providing apparatus and method and a content using apparatus and method, whereby when DRM content is transmitted, the integrity of the DRM content can be checked with only a small amount of transmission data and a small amount of computation.

The present invention also provides a content providing apparatus and method for revoking a content using apparatus determined as a non-authorized content using apparatus by efficiently determining an authorized DRM content using apparatus.

According to an aspect of the present invention, there is provided a content providing method comprising: generating an integrity check key for determining integrity of content constituted of at least one packet for every packet using information contained in the packet by the packet; generating a secret set, which is a set constituted of the integrity check key generated for every packet; generating a transport packet by packetizing the secret set with the content; and transmitting the transport packet.

According to another aspect of the present invention, there is provided a content providing apparatus comprising: a storage unit storing content constituted of at least one packet; a secret set generator generating an integrity check key for determining integrity of the content for every packet using information contained in the packet by the packet and generating a secret set, which is a set constituted of the integrity check key generated for every packet; a packetizer generating a transport packet by packetizing the secret set with the content; and a transmitter transmitting the transport packet.

According to another aspect of the present invention, there is provided a content using method comprising: receiving a transport packet containing content constituted of at least one packet and a secret set, which is a set constituted of integrity check keys generated for determining integrity of the content; storing the secret set extracted by processing the transport packet; determining using the secret set whether each packet constituting the content maintains integrity; and processing the packets, which are determined to be maintaining integrity.

According to another aspect of the present invention, there is provided a content using apparatus comprising: a receiver receiving a transport packet containing content constituted of at least one packet and a secret set, which is a set constituted of integrity check keys generated for determining integrity of the content, and extracting the secret set by processing the transport packet; a storage unit storing the secret set; a controller determining using the secret set whether each packet constituting the content maintains integrity; and a data processing unit processing the packets, which are determined to be maintaining integrity.

According to another aspect of the present invention, there is provided a content protecting system comprising: a content providing apparatus generating an integrity check key for determining integrity of content constituted of at least one packet for every packet using information contained in the packet and transmitting a transport packet generated by packetizing a secret set, which is a set constituted of the integrity check key generated for every packet, with the content; and a content using apparatus processing the transport packet, determining using the secret set contained in the transport packet whether each packet constituting the content maintains integrity, and processing the packets, which are determined to be maintaining integrity.

According to another aspect of the present invention, there is provided a content providing method comprising: setting a secret set, which is a set constituted of values generated in an authentication process between at least one authorized content using apparatus and a content providing apparatus; when a predetermined content using apparatus requests authentication from the content providing apparatus, determining whether a value generated in an authentication process between the predetermined content using apparatus and the content providing apparatus exists in the secret set; and if it is determined that the value does not exist in the secret set, revoking the predetermined content using apparatus.

According to another aspect of the present invention, there is provided a content providing apparatus comprising: a storage unit storing a secret set, which is a set constituted of values generated in an authentication process with at least one authorized content using apparatus; an authentication unit processing an authentication request from a predetermined content using apparatus; and a controller determining whether a value generated in an authentication process between the predetermined content using apparatus and the content providing apparatus exists in the secret set, and if it is determined that the value does not exist in the secret set, revoking the predetermined content using apparatus.

### BRIEF DESCRIPTION OF THE DRAWINGS

The above and other aspects of the present invention will become more apparent by describing in detail exemplary embodiments thereof with reference to the attached drawings in which:

FIG. 1 is a diagram for describing a method of determining the integrity of DRM content using MAC;

FIG. 2 illustrates a secret set, which is a set of integrity check keys for determining the integrity of content, according to an exemplary embodiment of the present invention;

FIG. 3 illustrates a content providing apparatus and a content using apparatus for determining the integrity of content according to an exemplary embodiment of the present invention;

FIG. 4 is a block diagram of the content providing apparatus illustrated in FIG. 3, according to an exemplary embodiment of the present invention;

FIG. 5 is a block diagram of the content using apparatus illustrated in FIG. 3, according to an exemplary embodiment of the present invention;

FIG. 6 is a flowchart of a content providing method according to an exemplary embodiment of the present invention;

FIG. 7 is a flowchart of a content using method according to an exemplary embodiment of the present invention;

FIG. 8 illustrates a content using apparatus and a content providing apparatus, which can revoke the content using apparatus, according to an exemplary embodiment of the present invention;

FIG. 9 is a block diagram of the content providing apparatus illustrated in FIG. 8, according to an exemplary embodiment of the present invention;

FIG. 10 illustrates a secret set having a hierarchical structure according to an exemplary embodiment of the present invention; and

FIG. 11 is a flowchart of a method of revoking a content using apparatus in a content providing apparatus according to an exemplary embodiment of the present invention.

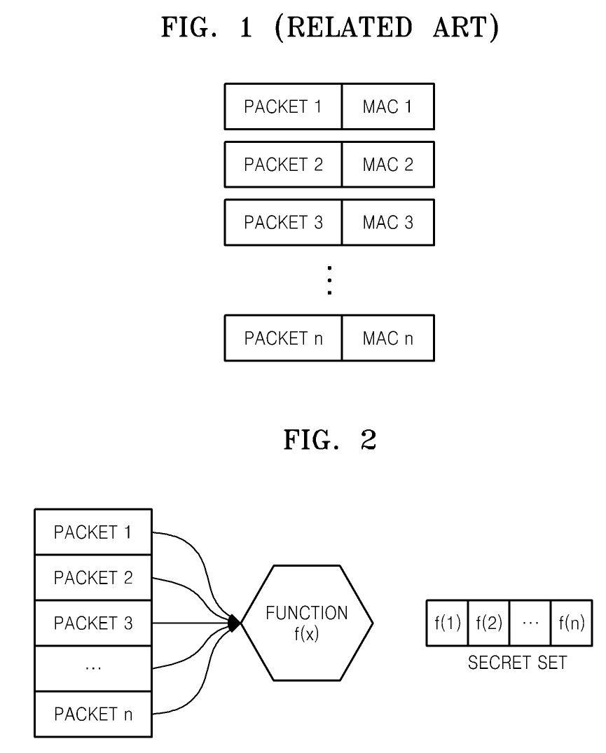

### DETAILED DESCRIPTION OF EXEMPLARY EMBODIMENTS OF THE INVENTION

Hereinafter, the present invention will be described in detail by explaining exemplary embodiments of the invention with reference to the attached drawings.

There is the concept of a secret set indicating a basic configuration for communicating with a group of entities, which cannot trust each other. That is, a set satisfying predetermined conditions is called a secret set, the conditions being: 1) any party can determine whether the party is a member of the set; 2) any party except an originator, which has generated the set, cannot test whether another party is a member; and 3) any party except the originator cannot determine the number of members of the set.

Hereinafter, a method and apparatus for efficiently determining the integrity of content using the concept of a secret set, and a method and apparatus for determining whether a content using apparatus is an authorized apparatus will now be described.

FIG. 2 illustrates a secret set, which is a set of integrity check keys for determining the integrity of content, according to an exemplary embodiment of the present invention.

Referring to FIG. 2, when content is formed by using packets (a packet 1, a packet 2, a packet 3, through to, a packet n), an integrity check key for determining the integrity of the content is generated for every packet using information contained in the packets constituting the content. An integrity check key is a value generated by applying information contained in each packet to a predetermined function, i.e., ƒ(x) in FIG. 2. In the current exemplary embodiment, since a set {ƒ(1), ƒ(2), . . . , ƒ(n)} of integrity check keys generated for the packets satisfies the conditions of a secret set, the set {ƒ(1), ƒ(2), . . . , ƒ(n)} is called a secret set.

In other words, a secret set according to an exemplary embodiment of the present invention is a set of values output from a predetermined function of which an input value is a predetermined value contained in each packet. The predetermined value contained in each packet is not limited so long as it is contained in the packet. For example, if data of each packet is binary data, the predetermined value contained in each packet may be the least or most significant bit of the data. Thus, values constituting a secret set can differ between respective packets. In addition, the predetermined function of which an input value is a predetermined value contained in each packet is not limited in its type.

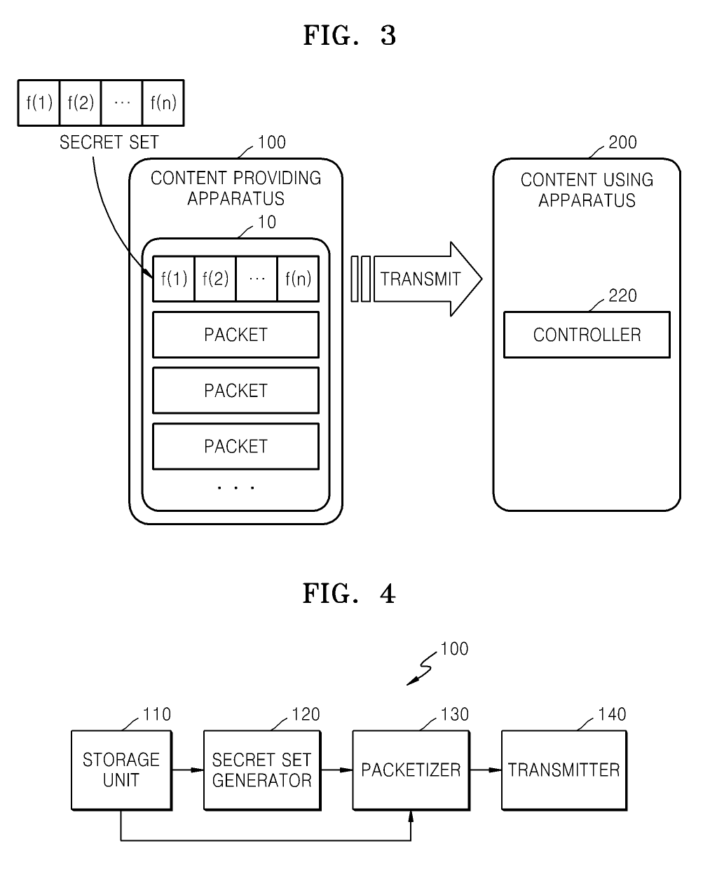

FIG. 3 illustrates a content providing apparatus 100 and a content using apparatus 200 for determining the integrity of content according to an exemplary embodiment of the present invention.

Referring to FIG. 3, the content providing apparatus 100 is an apparatus transmitting content via a predetermined path, and the content using apparatus 200 is an apparatus receiving and using the content transmitted from the content providing apparatus 100.

The content providing apparatus 100 generates an integrity check key for determining the integrity of content constituted of at least one packet for every packet using information contained in the packet, generates a transport packet 10 by packetizing a secret set, which is a set constituted of the integrity check key generated for every packet, with the content, and transmits the transport packet 10 to the content using apparatus 200.

When the content using apparatus 200 receives and processes the transport packet 10 containing the content, a controller 220 determines using the secret set contained in the transport packet 10 whether each packet constituting the content maintains integrity. The content using apparatus 200 processes the packets, which are determined to be maintaining integrity.

FIG. 4 is a block diagram of the content providing apparatus 100 according to an exemplary embodiment of the present invention. Referring to FIG. 4, the content providing apparatus 100 includes a storage unit 110, a secret set generator 120, a packetizer 130, and a transmitter 140.

The storage unit 110 stores content constituted of at least one packet.

The secret set generator 120 generates an integrity check key for determining the integrity of the content for every packet using information contained in the packet. The integrity check key is a value generated by applying information contained in a relevant packet to a predetermined function. The secret set generator 120 generates a secret set, which is a set constituted of the integrity check key generated for every packet.

The packetizer 130 generates a transport packet by packetizing the secret set with the content. When the transport packet is packetized, the secret set is inserted into a header of the transport packet. The transmitter 140 transmits the transport packet to the content using apparatus 200.

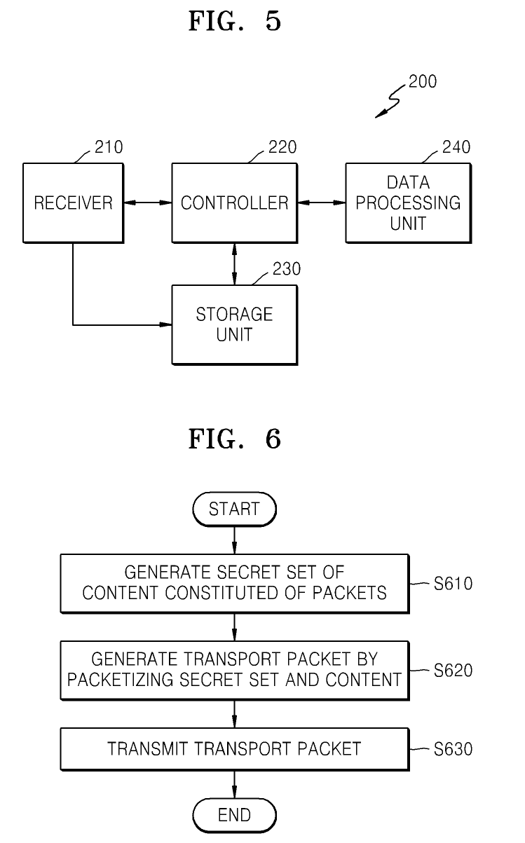

FIG. 5 is a block diagram of the content using apparatus 200 according to an exemplary embodiment of the present invention. Referring to FIG. 5, the content using apparatus 200 includes a receiver 210, a controller 220, a storage unit 230, and a data processing unit 240.

The receiver 210 receives a transport packet containing content constituted of at least one packet and a secret set, which is a set constituted of integrity check keys generated for determining the integrity of the content. When the receiver 210 extracts the content constituted of at least one packet and the secret set by depacketizing the transport packet, the content and the secret set are stored in the storage unit 230. In this case, the secret set is buffered by the storage unit 230.

The controller 220 determines using the secret set whether each packet constituting the content maintains integrity. In more detail, the controller 220 performs the same method as the method of generating an integrity check key in the content providing apparatus 100, using information contained in each packet constituting the received content.

That is, the controller 220 calculates an output value generated by substituting the information contained in each packet into the predetermined function used in the content providing apparatus 100. The information contained in each packet can be predetermined to use data of a specific position among data contained in the packet when each of the content providing apparatus 100 and the content using apparatus 200 generates an integrity check key. The controller 220 determines whether the output value matches a value contained in the secret set stored in the storage unit 230, i.e., whether the output value is a member of the secret set. If it is determined that the output value is a member of the secret set, the controller 220 determines that a relevant packet is a packet maintaining integrity without being forged or falsified by an unauthorized user. The controller 220 performs the above-described procedures for every packet contained in the transport packet.

The controller 220 transmits packets, which are determined to be maintaining integrity, to the data processing unit 240 so that the packets are processed. The data processing unit 240 performs necessary processing according to data contained in each packet. For example, the data processing unit 240 can include an Audio/Video (A/V) decoding module in order to process a packet containing A/V data.

If it is determined that an output value generated using a packet is not a member of the secret set, the controller 220 can determine that the packet has been forged or falsified, i.e., has lost integrity. The controller 220 can control the data processing unit 240 not to process a packet, which is determined to have lost integrity, or packets that are received after the packet, by determining that the packets have lost integrity.

FIG. 6 is a flowchart of a content providing method according to an exemplary embodiment of the present invention.

Referring to FIG. 6, in operation S610, an integrity check key for determining the integrity of content constituted of at least one packet is generated for every packet using information contained in the packet, and a secret set, which is a set constituted of the integrity check key generated for every packet, is generated. The integrity check key can be a value generated by applying information contained in a relevant packet to a predetermined function.

In operation S620, a transport packet is generated by packetizing the secret set with the content. The secret set can be inserted into a header of the transport packet.

In operation S630, the transport packet is transmitted to the content using apparatus 200.

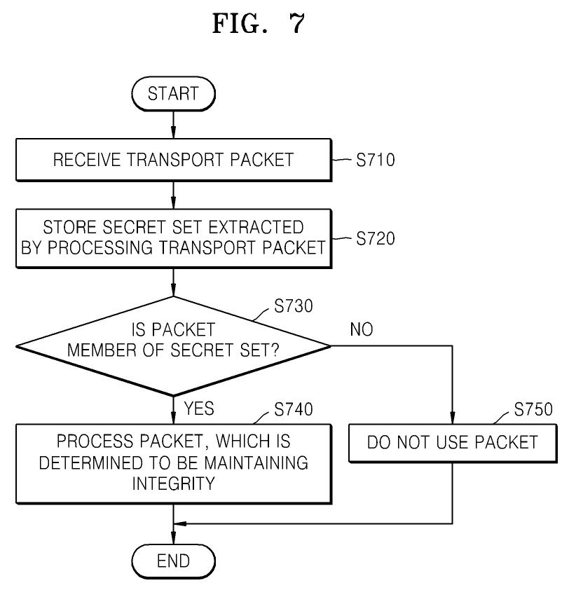

FIG. 7 is a flowchart of a content using method according to an exemplary embodiment of the present invention.

Referring to FIG. 7, in operation S710, a transport packet containing content constituted of at least one packet and a secret set, which is a set constituted of integrity check keys generated for determining the integrity of the content, is received.

In operation S720, the secret set, which is a set constituted of integrity check keys extracted from the header of the transport packet by processing, e.g. depacketizing, the transport packet, is stored.

In operation S730, it is determined whether each packet contained in the transport packet is a member of the secret set. That is, it is determined using the secret set whether each packet constituting the content maintains integrity.

Operation S730 can be performed as follows. A value (or an output value) generated using the information contained in each of the at least one packet is calculated by performing the same method as the method of generating an integrity check key in the content providing apparatus 100. For example, the output value can be generated using data of a specific position among data contained in the packet, which was used by the content providing apparatus 100, in the same function as that used for the content providing apparatus 100 to generate the integrity check key. If the output value exists in the secret set, i.e., if the output value is a member of the secret set, it can be determined that the data contained in the packet has not been forged or falsified.

In operation S740, packets, which are determined to be maintaining integrity, are processed.

Each packet, which is determined to have lost integrity since data of the packet has been forged or falsified by an unauthorized user, is processed in operation S750 so that the packet is not used in the content using apparatus 200.

A method of efficiently determining whether a content using apparatus, which can download or receive content from a content providing apparatus, is an authorized apparatus and revoking a content using apparatus, which is determined as an unauthorized apparatus, according to an exemplary embodiment of the present invention will now be described.

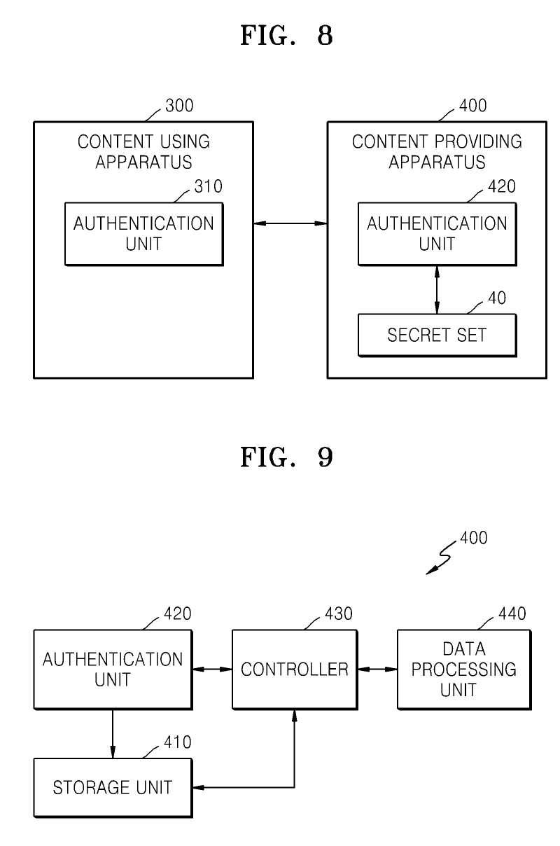

FIG. 8 illustrates a content using apparatus 300 and a content providing apparatus 400, which can revoke the content using apparatus 300, according to an exemplary embodiment of the present invention.

Referring to FIG. 8, the content using apparatus 300 performs authentication with the content providing apparatus 400 using authentication units 310 and 420 contained in the respective apparatuses 300 and 400. If the content providing apparatus 400 determines that the content using apparatus 300 is an authorized apparatus, the content providing apparatus 400 provides content requested by the content using apparatus 300. Various methods of providing content can exist according to a communication channel between the content using apparatus 300 and the content providing apparatus 400.

In the current exemplary embodiment, the content providing apparatus 400 stores a set constituted of values generated in an authentication process with at least one authorized content using apparatus. Since the set constituted of values generated in the authentication process between the content providing apparatus 400 and the at least one authorized content using apparatus satisfies the conditions of a secret set described above, the set is called a secret set in the current exemplary embodiment.

When the content using apparatus 300 requests to download content by accessing the content providing apparatus 400, the content providing apparatus 400 begins an authentication process with the content using apparatus 300. If a value generated during this authentication process exists in a secret set 40, the content providing apparatus 400 can determine that the content using apparatus 300 is an authorized apparatus. In this case, the content providing apparatus 400 provides the content requested by the content using apparatus 300.

The content using apparatus 300 can be implemented with a memory device including an authentication module. The content providing apparatus 400 can be implemented with a kiosk type device distributing content after performing an authentication process when the content using apparatus 300 accesses the content providing apparatus 400.

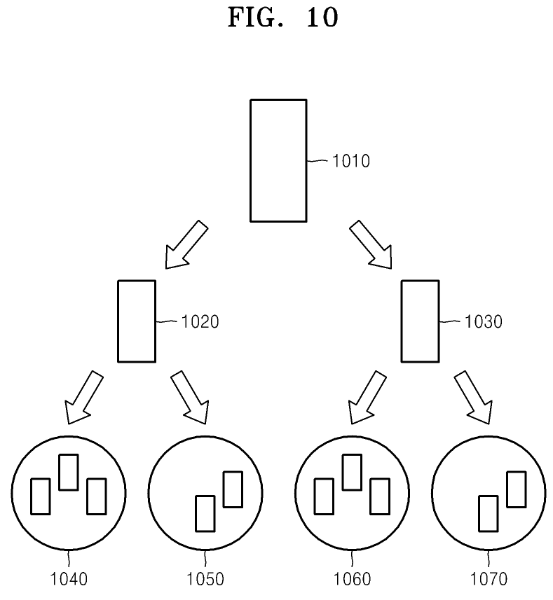

FIG. 9 is a block diagram of the content providing apparatus 400 according to an exemplary embodiment of the present invention. Referring to FIG. 9, the content providing apparatus 400 includes a storage unit 410, an authentication unit 420, a controller 430, and a data processing unit 440.

The storage unit 410 stores a secret set, which is a set constituted of values generated in an authentication process between the content providing apparatus 400 and at least one authorized content using apparatus.

A value generated in an authentication process between the content providing apparatus 400 and an authorized content using apparatus, which is a member of the secret set, may be a value calculated using a value transmitted from the authorized content using apparatus to the content providing apparatus 400 in an authentication key exchange.

Alternatively, a value, which is a member of the secret set, may be a value generated by using a value calculated using a value transmitted in an authentication key exchange. For example, if a value generated in an authentication process is an m-bit value, an n-bit value (n is less than m) generated by reducing the m-bit value can be used as a member of the secret set. In this case, a method of generating the n-bit value from the m-bit value can be determined by the content providing apparatus 400. Alternatively, a value, which is a member of the secret set, may be a bit value of predetermined data (or bits) of a value generated in an authentication process.

If an authentication protocol between an authorized content using apparatus and the content providing apparatus 400 is the Diffie-Hellman key exchange protocol, a value generated in the authentication process between the content providing apparatus 400 and the authorized content using apparatus may be a session key calculated using a secret key by the content using apparatus (or may be the secret key itself) or a value generated using the session key.

The secret set can be set by using the following method. The secret set can be provided, set, and updated to the content providing apparatus 400 for an authorized content using apparatus in a secret set originator (not shown) generating a set constituted of values generated in an authentication process between the content providing apparatus 400 and at least one authorized content using apparatus. When a predetermined content using apparatus 300 requests registration, the controller 430 can update the secret set by adding a value generated in an authentication process with the predetermined content using apparatus 300 to the secret set.

The content providing apparatus 400 can determine that only content using apparatuses that have requested registration including an authentication process and have passed a registration process are authorized apparatuses and can distribute content to the authorized apparatuses.

For example, if the content providing apparatus 400 is a kiosk type device and a content using apparatus is a memory device, when the content using apparatus passes an authentication process for registration to the content providing apparatus 400, a value generated in the authentication process is added to the secret set of the content providing apparatus 400 and stored in the content providing apparatus 400. When the content using apparatus accesses the content providing apparatus 400 at the next time content is to be downloaded, since a value generated in an authentication process is stored in the content providing apparatus 400, the content providing apparatus 400 can determine that the content using apparatus is an authorized apparatus. The content providing apparatus 400 can always reflect latest information on the secret set in various ways.

The authentication unit 420 processes an authentication request from a predetermined content using apparatus 300.

When the predetermined content using apparatus 300 accesses the content providing apparatus 400 in order to request authentication, the controller 430 determines whether a value generated in an authentication process between the predetermined content using apparatus 300 and the content providing apparatus 400 exists in the secret set, i.e., whether the value is a member of the secret set, and if it is determined that the value does not exist in the secret set, the controller 430 revokes the predetermined content using apparatus 300.

The controller 430 can separately manage a revocation list constituted of values generated in an authentication process between at least one revoked content using apparatus and the content providing apparatus 400. The controller 430 can generate the revocation list using a value generated in an authentication process between a predetermined content using apparatus 300, which was determined as an unauthorized apparatus and revoked, and the content providing apparatus 400. When a value generated in an authentication process between a predetermined revoked content using apparatus 300 and the content providing apparatus 400 does not exist in the revocation list, the controller 430 can update the revocation list by adding the generated value to the revocation list.

When the content providing apparatus 400 is used as a content using apparatus requesting and receiving content from another content providing apparatus (not shown), the authentication unit 420 can perform a function of transmitting a secret key to another content providing apparatus so that another content providing apparatus can calculate a value generated in an authentication process.

Although cases where a secret set is formed for authorized content using apparatuses have been described, a secret set can be formed for revoked content using apparatuses. In this case, when a value generated in an authentication process with a predetermined content using apparatus exists in the secret set, it can be determined that the predetermined content using apparatus is a revoked content using apparatus.

FIG. 10 illustrates a secret set having a hierarchical structure according to an exemplary embodiment of the present invention.

A secret set according to an exemplary embodiment of the present invention can be managed as a tree structure as illustrated in FIG. 10. A content providing apparatus 1010 performs a function of providing content, and content providing apparatuses 1020 to 1070 in other layers can act as content using apparatuses receiving content for an apparatus in an upper layer and content providing apparatuses providing content for apparatuses in a lower layer.

The content providing apparatus 1010 has a secret set constituted of values generated in an authentication process for the authorized content using and providing apparatuses 1020 and 1030 in a lower layer and can provide content to the content providing apparatus 1020 or 1030 when it is determined that the content providing apparatus 1020 or 1030 is an authorized apparatus. The content providing apparatus 1020 or 1030 has a secret set constituted of values generated in an authentication process for the content providing apparatuses 1040 to 1070 and can provide content to the content providing apparatus 1040, 1050, 1060 or 1070 when it is determined that the content providing apparatus 1040, 1050, 1060 or 1070 is an authorized apparatus.

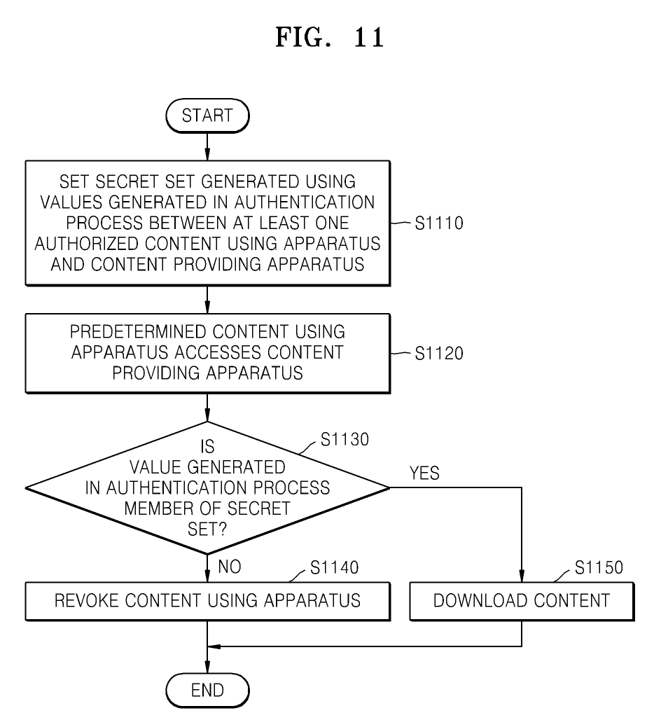

FIG. 11 is a flowchart of a method used by a content providing apparatus to determine whether a content using apparatus is an authorized apparatus and to revoke the content using apparatus when it is determined that the content using apparatus is an unauthorized apparatus according to an exemplary embodiment of the present invention.

Referring to FIG. 11, in operation S1110, a secret set, which is a set constituted of values generated in an authentication process between at least one authorized content using apparatus and the content providing apparatus 400, is set. Each value generated in the authentication process between the at least one authorized content using apparatus and the content providing apparatus 400 may be a value calculated using a value transmitted from the content using apparatus to the content providing apparatus 400 in an authentication key exchange or a value generated using the calculated value. If an authentication protocol between a predetermined content using apparatus and the content providing apparatus 400 is the Diffie-Hellman key exchange protocol, a value generated in an authentication process between the content providing apparatus 400 and the predetermined content using apparatus may be a session key or a value generated using the session key.

The secret set can be updated by a secret set originator. If at least one content using apparatus uses the content providing apparatus 400 by performing a registration process including authentication, when a predetermined content using apparatus requests registration from the content providing apparatus 400, the secret set can be updated by adding a value generated in an authentication process with the predetermined content using apparatus to the secret set.

In operation S1120, a predetermined content using apparatus 300 accesses the content providing apparatus 400 and requests authentication from the content providing apparatus 400.

In operation S1130, it is determined whether a value generated in an authentication process between the predetermined content using apparatus 300 and the content providing apparatus 400 exists in the secret set, i.e., whether the value is a member of the secret set.

If it is determined in operation S1130 that the value generated in the authentication process between the predetermined content using apparatus 300 and the content providing apparatus 400 is not a member of the secret set, since the predetermined content using apparatus 300 is an unauthorized apparatus, the predetermined content using apparatus 300 is revoked in operation S1140.

If it is determined in operation S1130 that the value generated in the authentication process between the predetermined content using apparatus 300 and the content providing apparatus 400 is a member of the secret set, since the predetermined content using apparatus 300 is an authorized apparatus, the content requested by the predetermined content using apparatus 300 is downloaded in operation S1150.

The content providing apparatus 400 can separately generate and manage a revocation list constituted of values generated in an authentication process between at least one revoked content using apparatus and the content providing apparatus 400. When a value generated in an authentication process between a predetermined revoked content using apparatus and the content providing apparatus 400 does not exist in the revocation list, the content providing apparatus 400 can update the revocation list by adding the generated value to the revocation list. If a secret set for authorized apparatuses has a larger amount of data than a revocation list, the content providing apparatus 400 can quickly determine using the revocation list whether a content using apparatus is an authorized apparatus.

The invention can also be embodied as computer readable codes on a computer readable recording medium. Also, functional programs, codes, and code segments for accomplishing the present invention can be easily construed by programmers skilled in the art to which the present invention pertains. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to the exemplary embodiments of present invention, there can be provided a content providing apparatus and method and a content using apparatus and method, whereby when content is transmitted, the integrity of the content can be checked using only a small amount of transmission data and a small amount of computation.

In addition, there can be provided a content providing apparatus and method for revoking a content using apparatus determined as a non-authorized content using apparatus by efficiently determining an authorized content using apparatus. Since the unauthorized content using apparatus can be revoked using a value generated in an authentication process between the content providing apparatus and the content using apparatus, even if a separate means of certification_does not exist, content can be provided to only authorized content using apparatuses.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of providing content in at least one packet, the method comprising:
generating an integrity check key for every packet of the content, wherein the integrity check key determines an integrity of the content for the every packet using information in the packet;
generating a secret set, which includes the integrity check key generated for the every packet;
generating a transport packet by packetizing the secret set with the content; and
transmitting the transport packet.

2. The method of claim 1, wherein the integrity check key is a value generated by applying information in the packet to a function.

3. The method of claim 1, wherein the secret set is inserted into a header of the transport packet.

4. An apparatus for providing content in at least one packet, the apparatus comprising:
a storage unit which stores the content of the at least one packet;
a secret set generator which generates an integrity check key for determining an integrity of the content for every packet using information in the packet, and generates a secret set, which includes the integrity check key generated for the every packet;
a packetizer which generates a transport packet by packetizing the secret set with the content; and
a transmitter which transmits the transport packet.

5. The apparatus of claim 4, wherein the integrity check key is a value generated by applying information in the packet to a function.

6. The apparatus of claim 4, wherein the packetizer inserts the secret set into a header of the transport packet.

7. A method of using content in at least one packet, the method comprising:
receiving a transport packet including the content in the at least one packet and a secret set, wherein the secret set includes an integrity check key generated for determining integrity of the content using information in the at least one packet;
storing the secret set extracted by processing the transport packet;
determining based on the secret key whether the at least one packet having the content maintains integrity; and
processing the at least one packet, if it is determined that the at least one packet having the content maintains integrity.

8. The method of claim 7, wherein the determining whether the at least one packet having the content maintains integrity comprises comparing a value, which is generated in a same method as the generating of the integrity check key transmitted through the transport packet using information in the at least one packet, to a value of the integrity check key in the secret set.

9. The method of claim 8, further comprising determining, based on a result of the comparing, that the at least one packet has lost integrity if the generated value of the at least one packet is not in the secret set.

10. The method of claim 8, wherein a packet whose generated value is not in the secret set as a result of comparison is determined as a forged packet and is not used.

11. An apparatus for using content in at least one packet, the apparatus comprising:
a receiver which receives a transport packet including the content in the at least one packet and a secret set, which includes an integrity check key, which is generated using information in the at least one packet, for determining an integrity of the content, and extracts the secret set by processing the transport packet;
a storage unit in which the secret set is stored;
a controller which determines, based on the secret set, whether the at least one packet having the content maintains integrity; and
a data processing unit which processes the at least one packet, if the controller determines that the at least one packet having the content maintains integrity.

12. The apparatus of claim 11, wherein the controller performs a same method as the generating of the integrity check key transmitted through the transport packet using information in the at least one packet and determines whether the value generated, based on of the performing, exists in the secret set.

13. The apparatus of claim 12, wherein if the value generated based on of the performing matches the stored integrity check key, the controller determines the at least one packet maintains integrity.

14. The apparatus of claim 12, wherein if the value generated based on of the performing does not exist in the secret set, the controller determines the at least one packet as a to be forged so that the at least one packet is not processed by the data processing unit.

15. A system for protecting content in at least one packet, the system comprising:
a content providing apparatus which generates an integrity check key for determining an integrity of the content in the at least one packet using information in the at least one packet and transmits a transport packet generated by packetizing a secret set, which includes the integrity check key generated for the at least one packet, with the content; and
a content using apparatus which processes the transport packet, determines, based on uses the secret set in the transport packet, whether the at least one packet having the content maintains integrity, and processes the at least one packet if it is determined that the at least one packet maintains integrity.

16. A computer readable recording medium storing a computer readable program for executing a method of providing content in at least one packet, the method comprising:
generating an integrity check key for determining an integrity of the content of the at least one packet using information in the at least one packet;
generating a secret set, which includes the integrity check key generated for the at least one packet;
generating a transport packet by packetizing the secret set with the content; and
transmitting the transport packet.

17. A computer readable recording medium storing a computer readable program for executing a method of using content in at least one packet, the method comprising:
receiving a transport packet including the of the at least one packet and a secret set, wherein the secret set includes an integrity check key generated for determining integrity of the content in the at least one packet;
storing the secret set extracted by processing the transport packet;
determining, based on the secret set, whether the at least one packet having the content maintains integrity; and
processing the at least one packet, if the at least one packet is determined that the at least one packet having the content maintains integrity.

18. A method of providing content in at least one packet, the method comprising:
setting a secret set, which includes values generated in an authentication process between at least one authorized content using apparatus and a content providing apparatus;
if a content using apparatus requests authentication from the content providing apparatus, determining whether a first value generated in an authentication process between the content using apparatus and the content providing apparatus exists in the secret set; and
if it is determined that the first value does not exist in the secret set, revoking the content using apparatus.

19. The method of claim 18, wherein the secret set is updated by a secret set originator generating the secret set.

20. The method of claim 18, wherein the setting of the secret set comprises adding the first value, which is generated in the authentication process with a content using apparatus if the content using apparatus requests registration, to the secret set.

21. The method of claim 18, wherein the first value generated in the authentication process corresponds to a calculated value which is calculated using a second value transmitted from the content using apparatus to the content providing apparatus in an authentication key exchange, or generated using the calculated value.

22. The method of claim 18, wherein the first value generated in the authentication process is a session key or a generated using the session key if an authentication protocol between the content using apparatus and the content providing apparatus is a Diffie-Helman key exchange protocol.

23. The method of claim 18, further comprising:
generating a revocation list of values generated in an authentication process between at least one revoked content using apparatus and the content providing apparatus; and
if the first value generated in the authentication process between a revoked content using apparatus and the content providing apparatus does not exist in the revocation list, updating the revocation list by adding the first value to the revocation list.

24. An apparatus for providing content in at least one packet, the apparatus comprising:
a storage unit which stores a secret set, which includes values generated in an authentication process with at least one authorized content using apparatus;
an authentication unit which processes an authentication request from a content using apparatus; and
a controller which determines whether a first value generated in an authentication process between the content using apparatus and the content providing apparatus exists in the secret set, and if it is determined that the first value does not exist in the secret set, revokes the content using apparatus.

25. The apparatus of claim 24, wherein the secret set is updated by a secret set originator which generates the secret set.

26. The apparatus of claim 24, wherein the controller adds the first value, which is generated in the authentication process with a content using apparatus if the content using apparatus requests registration, to the secret set.

27. The apparatus of claim 24, wherein the first value generated in the authentication process corresponds to a calculated value which is calculated using a second value transmitted from the content using apparatus to the content providing apparatus in an authentication key exchange, or generated using the calculated value.

28. The apparatus of claim 24, wherein the first value generated in the authentication process is a session key or generated using the session key if an authentication protocol between the content using apparatus and the content providing apparatus is a Diffie-Helman key exchange protocol.

29. The apparatus of claim 24, wherein if a revocation list of values in an authentication process between at least one revoked content using apparatus and the content providing apparatus exists, if the first value generated in the authentication process between a revoked content using apparatus and the content providing apparatus does not exist in the revocation list, the controller updates the revocation list by adding the first value to the revocation list.

30. A computer readable recording medium storing a computer readable program for executing a method of revoking a content using apparatus in a content providing apparatus, wherein the content using apparatus uses content in at least one packet and the content providing apparatus provides the content, the method comprising:
setting a secret set, which includes values generated in an authentication process between at least one authorized content using apparatus and a content providing apparatus;
if a content using apparatus requests authentication from the content providing apparatus, determining whether a value generated in an authentication process between the content using apparatus and the content providing apparatus exists in the secret set; and
if it is determined that the value does not exist in the secret set, revoking the content using apparatus.

31. A method of providing content in at least one packet of a plurality of packets, the method comprising:
generating an integrity check key for the at least one packet, wherein the integrity check key determines an integrity of the content for the at least one packet using information in the at least one packet;
generating a secret set, which includes the integrity check key generated for the at least one packet;
generating a transport packet by packetizing the secret set with the content; and
transmitting the transport packet.

32. An apparatus for providing content in at least one packet of a plurality of packets, the apparatus comprising:
a storage unit which stores the content of the at least one packet;
a secret set generator which generates an integrity check key for determining an integrity of the content in the at least one packet using information in the at least one packet, and generates a secret set, which includes the integrity check key generated for the at least one packet;
a packetizer which generates a transport packet by packetizing the secret set with the content; and
a transmitter which transmits the transport packet.
